(19) United States
(12) Patent Application Publication
(10) Pub. No.: US 2025/0237583 A1
(43) Pub. Date: Jul. 24, 2025

(54) AUTOMATIC SYSTEM AND METHOD FOR TISSUE SECTIONING, STAINING, AND SCANNING

(71) Applicants: MicroVizual Inc., New York, NY (US); THE UNIITED STATES OF AMERICA, as represented by the Secretary, Department of Health and Human Servi, Bethesda, MD (US)

(72) Inventors: Zhengping Zhuang, Bethesda, MD (US); Young Wan Moon, Seoul (KR)

(21) Appl. No.: 18/700,977

(22) PCT Filed: Oct. 12, 2022
(86) PCT No.: PCT/US2022/046406

§ 371 Date: Apr. 12, 2024

Related U.S. Application Data
(60) Provisional application No. 63/254,743, filed on Oct. 12, 2021.

(51) Int. Cl. G01N 1/30; G01N 1/06; G01N 1/31; G01N 35/00

(52) U.S. Cl. CPC G01N 1/30; G01N 1/06; G01N 1/31; G01N 35/00029; G01N 2001/061; G01N 2035/00138

(57) ABSTRACT

A system and method for processing biological samples including a sample cutter to cut sample slices, a moving tape, a staining module, an imaging unit, and a computing system. The moving tape is configured to collect and align the sample slices consecutively according to their cutting order. The staining module is configured to transfer the moving tape through the staining module for staining and the plurality of sample slices on the moving tape are processed while in the staining module. The imaging unit is configured to image the stained moving samples and to collect digital images of the sample slices consecutively according to their cutting order. The computing system is configured to receive the collected and consecutive digital images of the plurality of sample slices and to combine the collected and consecutive digital images into a three dimensional image.

### FIELD OF THE INVENTION

The field of the invention is related to diagnostic systems and methods. More specifically, it presents systems and methods in the field of clinical pathology to automate processes of sectioning, staining, and imaging histologic specimens as well as to facilitate information analysis and disease diagnosis.

### CROSS-REFERENCE TO RELATED APPLICATIONS

This application claims the benefit of U.S. Provisional Patent Application Ser. No. 63/254,743, filed Oct. 12, 2021, the disclosure of which is incorporated by reference herein in its entirety.

### BACKGROUND OF THE INVENTION

The importance of pathology to modern medicine cannot be overemphasized. In cancer treatment for example, precise pathological reading of invasive regions of cancer on a biopsy is a critical step in enabling an effective therapy design. Throughout a history of more than a century, pathology-based evaluations have always been an indispensable part for diagnosing a disease.

Despite of being a traditional approach, the histomorphologic evaluation still relies on examining slides mounted with quality tissue sections. However, preparing good tissue slides suitable for clinical use not only is labor intensive, but also requires skills from a highly trained histological technician. Currently the supply of such qualified technicians is not keeping up with the increasing volume of tissue-based testing. Thus, there is a need to develop new methods, preferably with automation technology, that can minimize some of the tedious tasks required for preparation of tissue slides.

On the other hand, the advent of the digital age, especially aided by nowadays artificial intelligence (AI), spawns a nascent, yet rapid-evolving field called digital pathology. Digital pathology refers to technologies and techniques to capture, store, and interpret information about pathologic specimens with digitally formatted images. Compared to the tradition of working through a light microscope, digital pathology enables viewing images through a computer interface and transmission of tissue images through internet. Leveraging digital pathology's rapid development, the field of AI explores so-called cognitive technologies that can simulate human reasoning and perceptual abilities for analyzing medical imaging to improve disease prediction and diagnosis. While digital pathology transforms static images into retrievable data, facilitating the acquisition of increasing amounts of information from histologic specimens, the field of AI promises to advance subsequent qualitative and quantitative analyses of that information.

As digital pathology grows hand-in-hand with the AI technology, it calls for increasingly insatiable amount of data. However, besides the above-mentioned production challenge with quality tissue sections, the current image scanning/acquisition also lags behind. Typical microscope-based reading of pathology images takes times for processing and is not amenable for a high throughput approach. Further, for any given tissue sample, its images, by the current standard, are limited only to 2-D views of several random sections. How to improve upon the current standard to acquire more information from that given tissue sample, more importantly, how to drastically improve on scanning technology to achieve high throughput image acquisition becomes a challenge in the age of AI-focused digital pathology.

Therefore, a need exists for a system or method that eliminates the use of tissue slides to prepare tissue samples and instead uses a tape or film for holding sequentially cut tissue slices from a cutting operation to a final step of capturing digital images of the cut tissue slices.

### SUMMARY OF THE INVENTION

This invention provides systems and methods that streamline the process from preparing tissue slides to capturing digital images to meet the demand of generating multi-layer 3D images for Artificial Intelligence (AI)-focused digital pathology. At the same time, it promises to acquire more holistic information from a tissue sample to enhance the coverage of histology areas for better pathology diagnosis.

The present invention further provides a system to advance digital pathology which is designed such that when a formalin-fixed, paraffin-embedded (FFPE) tissue sample is processed by a microtome, continuous sectioning is conducted while sample sections are transferred onto a carrier film or tape. The carrier film or tape boasts a number of advantages so that dozens of sample sections are placed on the film or tape and can be processed, e.g., histologically stained. In another embodiment, a tape, especially a coated tape, is used as an alternative to the film to hold the sample sections.

The present disclosure provides a versatile tape to be used to carry sequentially cut sample slices to the downstream processing steps, e.g., staining and imaging, that can be automated and designed to be high throughput.

One aspect of this invention relates to a method of processing a biological sample. The method includes the steps of: (i) cutting the biological sample into a plurality of sample slices with equal thickness; (ii) transferring the plurality of sample slices sequentially onto a moving tape; (iii) advancing the moving tape into a staining cassette; (iv) processing the plurality of sample slices simultaneously in a staining module; and (v) feeding the stained tape to an imaging unit, the imaging unit configured to image one sample slice at a time and to collect digital images of the plurality of sample slices consecutively according to their cutting order.

In one or more embodiments of the present method, the sample can be a tissue, for example, a formalin-fixed, paraffin-embedded tissue. The moving tape is configured to collect and align the plurality of sample slices consecutively according to their cutting order. In one embodiment, the sample slices are placed on a moving tape that moves through dewaxing, staining, and rinsing modules, and through an image scanning system which images each of the sample slices sequentially. Once imaged, a computer system is configured to recombine the scanned images into a 3 dimensional image file that can be viewed in three dimensions.

In another system and method, a staining cassette is configured to hold the tape and the plurality of sample slices thereon. There may be multiple embodiments for the staining cassette. In one embodiment, the staining cassette can be a staining tray. In another embodiment, the staining cassette can be a staining wheel.

The processing comprises dewaxing, dehydrating, staining, or a combination thereof.

Another aspect of this invention relates to a device for collecting and processing a sample. The device includes: (i) a sample cutter, comprising a blade and a cradle configured to hold a sample, wherein either the blade or the cradle is movable to ensure the blade makes a series of cut of the sample into a plurality of sample slices with equal thickness; (ii) a moving tape, the moving tape configured to collect and align the plurality of sample slices consecutively according to their cutting order; (iii) a staining chamber, and (iv) an imaging unit.

In one embodiment of the above described, the device is configured to, after the sample cutter makes a slice from the sample, apply a force to the slice to transfer and mount the slice onto the moving tape. The moving tape advances into a staining module while the staining module is configured to hold the tape for a period of time and the plurality of sample slices thereon. The plurality of sample slices are simultaneously processed while in the staining chamber and the processing includes dewaxing, dehydrating, staining, or a combination thereof. Finally, the imaging unit is configured to image the stained moving tape and to collect digital images of the plurality of sample slices consecutively according to their cutting order.

Yet another aspect of this invention relates to a method for processing a biological sample. The method includes: (i) cutting the biological sample into a plurality of sample slices with equal thickness; (ii) transferring the plurality of sample slices sequentially onto a moving tape, the moving tape configured to collect and align the plurality of sample slices consecutively according to their cutting order; (iii) advancing the moving tape through a processing modules or chamber that dewaxes, dehydrates, and stains the plurality of sample slices; and (iv) feeding the stained moving tape to an imaging unit, the imaging unit configured to image one sample slice at a time and collect digital images of the plurality of sample slices consecutively according to their cutting order.

Still another aspect of this invention relates to a device for collecting and processing a sample. The device includes: (i) a sample cutter, comprising a blade and a cradle configured to hold a sample, wherein either the blade or the cradle is movable to ensure the blade makes a series of cut of the sample into a plurality of sample slices with equal thickness; (ii) a moving tape, the moving tape configured to collect and align the plurality of sample slices consecutively according to their cutting order; (iii) a staining chamber, and (iv) an imaging unit.

In one or more embodiments of the device, the device is configured, after the sample cutter makes a slice from the sample, to apply a force to the slice to transfer and mount the slice onto the moving tape. Also, the moving tape advances through a dewaxing chamber, a staining chamber that and stains the plurality of sample slices. An imaging unit is configured to image the stained moving tape and collect digital images of the plurality of sample slices consecutively according to their cutting order. A computing system configures the consecutive slices into a 3D image.

In one embodiment, there is provided a system for processing a biological sample including a sample cutter having a blade and a cradle configured to hold a sample embedded in a wax, wherein either the blade or the cradle is movable to ensure the blade makes a series of cuts of the sample into a plurality of sample slices with equal thickness. A moving tape is configured to collect and align the plurality of sample slices consecutively according to a cutting order. A staining module is configured to transfer the moving tape through the staining module and the plurality of sample slices on the moving tape are processed while in the staining module, wherein the staining module stains the samples. An imaging unit is configured to image the moving stained sample slices and to collect digital images of the plurality of sample slices consecutively according to their cutting order.

In another embodiment, there is provided a method for processing a biological sample. The method includes: sectioning the biological sample into a plurality of sample slices; transferring the plurality of sample slices sequentially onto a moving tape, the moving tape configured to collect and align the plurality of sample slices consecutively according to their cutting order; advancing the moving tape through a processing system that prepares the plurality of sample slices for reconstruction into a three dimensional image; advancing the processed moving tape to an imaging unit, wherein the imaging unit is configured to image one sample slice at a time and to collect digital images of the plurality of sample slices consecutively according to their cutting order; and transferring the collected digital images to a computing system configured to combine the collected and consecutive digital images into the three dimensional image.

In a further embodiment, there is provided a method for processing a biological sample. The method includes: cutting the biological sample into a plurality of sample slices with equal thickness; transferring the plurality of sample slices sequentially onto a moving tape, the moving tape configured to collect and align the plurality of sample slices consecutively according to their cutting order; advancing the moving tape into a staining cassette, the staining cassette configured to hold the tape and the plurality of sample slices thereon; processing the plurality of sample slices simultaneously in the staining cassette, wherein the processing comprises dewaxing, dehydrating, staining, or a combination thereof; and feeding the stained tape to an imaging unit, the imaging unit configured to image one sample slice at a time and collect digital images of the plurality of sample slices consecutively according to their cutting order.

In an additonial embodiment, there is provided a device for collecting and processing a sample. The device includes a sample cutter, comprising a blade and a cradle configured to hold a sample, wherein either the blade or the cradle is movable to ensure the blade makes a series of cut of the sample into a plurality of sample slices with equal thickness. Amoving tape is configured to collect and align the plurality of sample slices consecutively according to their cutting order. A staining chamber includes one or more staining cassettes. An imaging unit configured to, after the sample cutter makes a slice from the sample, apply a force to the slice to transfer and mount the slice onto the moving tape, wherein the moving tape advances into a staining cassette. The staining cassette is configured to hold the tape and the plurality of sample slices thereon. The plurality of sample slices are simultaneously processed in the staining chamber, wherein the processing includes dewaxing, dehydrating, staining, or a combination thereof, and the imaging unit is configured to image the stained moving tape and to collect digital images of the plurality of sample slices consecutively according to their cutting order.

In another embodkment, there is provided a method for processing a biological sample. The method includes: cutting the biological sample into a plurality of sample slices with equal thickness; transferring the plurality of sample slices sequentially onto a moving tape, the moving tape configured to collect and align the plurality of sample slices consecutively according to their cutting order; advancing the moving tape through a processing chamber that dewaxes, dehydrates, and stains the plurality of sample slices with automated liquid-handling pipettes or liquid handlers; and feeding the stained moving tape to an imaging unit, the imaging unit configured to image one sample slice at a time and collect digital images of the plurality of sample slices consecutively according to their cutting order.

In a further embodiment, there is provided a device for collecting and processing a sample including a sample cutter having a blade and a cradle configured to hold a sample, wherein either the blade or the cradle is movable to ensure the blade makes a series of cuts of the sample into a plurality of sample slices with equal thickness. A moving tape is configured to collect and align the plurality of sample slices consecutively according to their cutting order. The device is configured to, after the sample cutter makes a slice from the sample, apply a force to the slice and to transfer and mount the slice onto the moving tape. The moving tape advances through a staining chamber that dewaxes, dehydrates, and stains the plurality of sample slices with automated liquid handlers. An imaging unit is configured to image the stained moving tape and collect digital images of the plurality of sample slices consecutively according to their cutting order.

The details of the invention are set forth in the drawing and the description below. Other features, objects, and advantages of the invention will be apparent to those persons skilled in the art upon reading the drawing and the description, as well as from the appended claims.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1A illustrates a diagram of a conventional microtome blade cutter to provide a formalin fixed, paraffin embedded tissue section;

FIG. 1B illustrates the cutter of FIG. 1A which applies the FFPE section onto a tape;

FIG. 2A illustrates a top view of a tape carrying the applied FFPE sections;

FIG. 2B illustrates a diagrammatic side view of a continuous tape having applied FFPE sections through tape processing modules;

FIG. 3 illustrates a continuous processing system for processing a continuous tape having applied FFPE sections;

FIG. 4 is a illustrates a rotating staining wheel for staining the tape carrying sequential sample slices;

FIGS. 5A and 5B illustrate respectively a side view and a top view of the rotating staining wheel of FIG. 4;

FIG. 6 illustrates another rotating staining wheel for staining the tape carrying sequential sample slices;

FIGS. 7A and 7B illustrate two different side views of the staining wheel of FIG. 6;

FIGS. 8A and 8B illustrate a staining tray for staining the tape carrying sequential sample slices; and

FIG. 9 illustrates a top views of the staining tray of FIG. 8 including a tape segment.

### DETAILED DESCRIPTION

Methods, systems, and devices, are provided for acquiring consecutive images of a series of tissue sections. Aspects of the methods include preparing a series of parallel slices of a tissue sample, the thickness of the parallel slices being substantially the same. Also provided are devices and apparatus practicing the subject methods.

Before the present methods or systems are described, it is to be understood that this invention is not limited to particular method described, as such may, of course, vary.

Hereinafter, exemplary embodiments of the present invention will be described in detail with reference to the accompanying drawings so that those of ordinary skill in the art can carry out the present invention. However, it should be understood that the present invention can be implemented in various forms and is not intended to limit the exemplary embodiments of the present invention. Also, in the drawings, descriptions of parts unrelated to the detailed description are omitted to clearly describe the present invention.

The subject systems and methods are useful primarily for diagnostic purposes. Yet, the successful implementation of these systems and methods brings a prospect of transforming the practice of pathology, and to further leap it into a quantitative science.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

Embodiments of the invention provide advantageous features and characteristics in the areas of the tissue section, the tissue staining, the camera, image identification, and/or automated image analysis, including methods, systems and/or devices of manufacture. Note the terms “determining,” “measuring,” and “assessing,” and “assaying” are used interchangeably and include both quantitative and qualitative determinations.

The sample processed and analyzed by this invention is a biological sample.

Specifically, the sample is any tissue collected via biopsy or dissection that requires histological analysis. The sample is a formalin-fixed, paraffin-embedded (FFPE) tissue sample prior to processing with this invention.

The primary aspects of this invention relate to an integrated method of sample processing comprising: (i) continuous sample sectioning; (ii) transfer of the sample sections onto a support such as a film or tape, and may include subsequent grouping of multiple samples and/or transfer to a processing stage; (iii) dewaxing via thermal and chemical applications; (iv) tissue staining, such as but not limited to haemotoxylin and eosin (H&E), immunohistochemistry (IHC), immunofluorescent-based (IF) staining, or other special staining protocols, applied via batch staining in serial reagent baths or droplet application of reagents; (v) sealant application; (vi) analog image amplification, digital scanning, and image collection/storage; (vii) three-dimensional image stacking and reconstruction; (viii) AI analysis of processed samples. The just-described method is achieved such that each step may be designed as a module or component of the integrated device, with multiple configurations of the device being able to perform the fundamental aspects of the inventions depending on the specific needs of the user. Multiple and alternate configurations of the present invention are detailed herein.

The invention is designed to carry out standard sectioning protocol utilizing a traditional microtome design comprising a cradle configured to hold a sample and a blade. Traditionally, cradle and sample move such that the paraffin block is forced against the cutting edge of the blade to generate a slice of uniform thickness. Alternatively, the blade may move orthogonal to the motion of the cradle to facilitate slicing; a vibratome can also be incorporated. The thickness of the samples can be adjusted by the user.

A camera may also be incorporated into the design of the microtome. This camera would be positioned normal to and facing the center of the surface of the tissue sample block. The camera is present to aid in quality control. The camera will take a reference picture of the block face prior to each slice. A scale bar or marking of known dimensions would be present on either the cradle or cassette of the sample. The image can be referenced later to aid in alignment and error correction when reconstructing the stack of the scanned images.

The present invention processes the samples continuously and transfers each slice, consecutively and equidistantly, onto a plastic film or tape. The film is positioned near the blade such that the slice will contact the film or tape and adhere thereto. The film or tape is moving at a velocity consistent with the slicing so as to minimize wrinkling or tearing of the section during transfer. By design, the net negative change of the plastic film or tape and the net positive charge of FFPE tissue samples aids in the transfer. In addition, the sample block surface and film or tape may be sprayed with an aqueous solution prior to slicing; the cohesion of the water will aid in transfer. A mechanism could be included to apply force to the slice to aid in adherence. The film or tape may also be coated with a chemical layer or adhesive that promotes adherence of tissues sections. The plurality of sample slices are mounted to the film following the cutting order. Microtomy proceeds until the entire or desired thickness of sample is sliced, or, in some cases, until the sample mounting stage is full.

The plastic film, or tape, is stored in a roll or spool and unwound at a rate consistent with the rate of sample slicing. To maintain precise control of the film and the position of the section on the film, the film or tape, in one embodiment, is designed with a series of equidistantly spaced holes along the lateral edges, down the length of the film or tape. Sprockets are used to transition the film between modules throughout the device. The cogs of these sprockets align with the holes in the film or tape, resulting in precise control of the movement of the film or tape. This is of importance when aligning the samples with a sealant or staining applicator, and, in some variants, while scanning. The film or tape is both optically transparent and heat resistant up to at least 60° C.; this temperature is relevant for dewaxing.

In one embodiment, the sections are transferred onto a continuous tape that moves continuously from a sectioning station, to dewaxing, staining, and rinsing modules, to a scanning module, and to a computing system.

The dewaxing module serves to melt the paraffin wax by heating the samples; all other liquid reagent washes typically used for dewaxing, such as ethanol solutions and xylene, can be applied by the staining modules, as those modules are designed for liquid chemical application. The dewaxing module heats each sample to approximately 55° C. for up to 10 minutes. The general design can be that of an oven or a heated surface.

In one embodiment, the staining module serves to apply liquid reagents that complete the dewaxing processes, as well as to stain the tissue sample. Two variations of the staining module can be integrated into the device. The first embodiment of the staining module utilizes a reagent bath design, in which the samples are submerged and incubated in a series of liquid reagents baths, as required for the particular staining protocol. In another embodiment, the film or tape moves through a series of modules, each providing a different function including dewaxing, staining and rinsing.

In all embodiments of the staining module, the method of staining would be designated by the user. The reagent bath variant could be capable of performing 1) standard H&E staining, 2) IHC, 3) IF, and 4) various special staining protocols. The particular regents for each could be loaded into the module manually or automatically, and protocols could be indicated by the user via a user interface. Due to the cost of antibodies and non-standard staining reagents, the reagent bath variant is well-suited for standard H&E staining, whereas the other staining protocol may benefit from the more precise application performed by a staining module.

In one embodiment, a sealing module serves to apply a transparent cover to the stained samples. This cover is designed to prevent drying and damage to the samples through the processes of scanning and analysis, as well as during storage. One of three varieties of the sealing modules may be integrated into the device, depending on the needs of the user. The first embodiment of the sealing module dispenses a liquid sealant onto each sample. Application of the sealant would be both controlled and of defined volume, a similar method as the auto-dispensing staining module. In certain embodiments of the integrated device, this sealing module variant could be integrated into the staining module. This variant can be used with all embodiments of the present invention. The second and third variants of the sealing module apply primarily to the embodiment of the present invention that utilizes direct mounting of the sections onto the film or tape.

The scanning module serves to capture and store a digital image of all stained tissue samples. One embodiment of this module utilizes a high-resolution digital camera that captures an image of a sample or plurality of sample within the field of view (FOV). For example, for use in the continuous feed variants of the present invention, this high-resolution camera could capture an image of each section sequentially. Alternatively, the camera FOV could capture a region of some or all samples on the film or tape. Another embodiment of the scanning module incorporates an array of high-resolution digital cameras. The FOV of each camera could capture a region of the film or tape, such that each image contains one or a plurality of tissue sections. This variant is designed to reduce the time spent scanning the film or tape, if the FOV of the camera is limited by the desired resolution. In yet another embodiment of the scanning module, a light projector could be used to illuminate one side of the stained tissue section. As the light passes through the sample, the analog image could be amplified through a series of lenses and captured by a high-resolution, polychromatic, digital detector array. The sensor of the detector array would require a suitably large number of pixels such that the effective resolution remains high after digital conversion and binning. The sensor would also need to be large enough to capture the entirety of the projected and amplified image. This just-described embodiment of the scanning module could be integrated into all embodiments of the present inventions; however, it would be well-suited for the single-ribbon, continuous-processing variants.

The remaining aspects of the present invention describe the features and functions of the software. The software performs three actions; 1) generate a three-dimensional reconstruction of the tissue sample; 2) differentiate tissue types within the reconstruction, allowing the user to filter certain tissue types from the reconstruction and highlight target tissues within the sample; 3) use AI for machine learning to facilitate disease diagnosis.

Reconstruction is accomplished by first identifying and ordering the individual tissue sections. If image capture is performed consecutively, digital images should be stored in the correct order. If using certain embodiments of the invention, such as the scanning module that captures all samples on the tape or film, a separate algorithm may be implemented to 1) identify and number each section within the given image, and 2) save a new set of images, each containing only one section. In certain embodiments, a stitching function may be required to first generate a complete image of tissue slices. Once individual images are saved and ordered, a process of quality control and error correction may be implemented. By matching the high-resolution image of the processed tissue samples with the reference images taken just prior to slicing, alterations to relative position, rotation, and morphology can be observed. To aid in this process, a virtual scale or reference marker can be overlaid onto the high-resolution image. Once all images are stacked in order and corrected for errors, the process of reconstruction can begin. The reconstruction algorithm would utilize the known thickness of each cut to interpolate between 2D images and form a 3D model of the processed tissue samples.

Once reconstruction is complete, AI analysis will take place. By observing the staining patterns within the reconstruction and cross-referencing histological image databases of known cell types, both physiologic and pathologic, the AI system will identify and indicate features of the tissue sample including, but not limited to, gross structure both physiologic and pathologic, tissue type and boarders, vascular networks, etc. The software also generates dynamic 3D model of the tissue sample in which certain tissues and structures can be highlighted or removed, depending on the goals of the user.

A user interface, most likely presented in the form of a computer application, will be used to manage the setting of the type of modules used in the system, the features of each of the modules, and to manipulate and to edit the dynamic 3D reconstruction. Some features that may be controlled by the user include sample thickness, staining protocols, and image resolution. This list is not exhaustive. Users may also be required to indicate which embodiment of the device is in use, including which modules are incorporated.

The present invention is designed to combine all processes of histology into one high-throughput, integrated device. The modular nature of each component allows for great variation in the final design of the system. Determining which variant to use depends on the type of sample being analyzed and methods of analysis, especially which staining protocols. Certain modules described above can be used independently, or, in certain cases, omitted if manual processing is desired; however, the present invention is intended to be developed as an autonomous, integrated system with no or minimal user input.

The present application is related to application number U.S. 62/820,604 having a priority date of Mar. 19, 2019, and which was filed as PCT/US2020/023644, having an international filing date of Mar. 12, 2020, the disclosures of which are each incorporated herein by reference in their entirety.

The following examples and figures explains the present invention more concretely but does not limit the range or scope of the present invention.

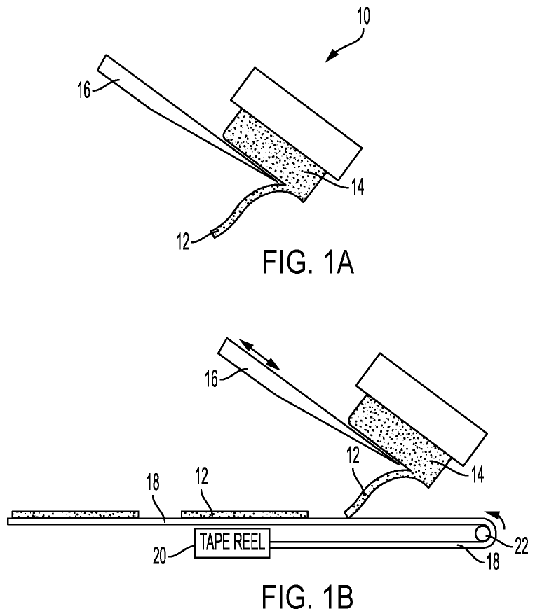

FIGS. 1A and 1B are diagrams of one embodiment of the present invention in which a single, continuous ribbon of tape, or a film, transports sample sections sequentially past a sectioning module 10. In FIG. 1A, a sample 12 is first sectioned from a block of FFPE sample tissue 14 by a cutting blade 16, such as a microtome blade, which separates a slice of the sample 12 from the sample block 14. The tissue sample 12 is then placed, or loaded, onto a continuous section of tape 18 as seen in FIG. 1B. The tape 18 is pulled from a reel of tape 20 that includes a supply of tape 18 that is configured to support the application of the sample 12. In one embodiment, one side of the tape is treated with a fixative to enhance attachment of the sample to the surface of the tape.

While there is no limitation in the selection of materials for making the tape, it should be understood that the tape thus prepared should be heat resistant up to ˜65C, chemically stable (e.g., resistant to Xylene or Alcohol treatment), and optically transparent. Representative chemical polymers which may be used for the tape include poly-vinyl chloride (PVC), bi-axially oriented polyethylene terephthalate (BOPET), and polyimide. It should be understood that different thicknesses, transparency, and elasticity of the tape may be selected by varying material selection and manufacturing conditions. Initially, the tape is expected to guide the motion of a sample section so that it can be transported from the microtone to the tape. Then, the surface tension between a sample section and the tape surface can be used to keep the sample section robustly adhered to the tape during transport and subsequent dewaxing or staining treatment without loss of conformation. Surface coating may be used to promote surface adhesion of the tape. Representative coating material can be poly-lysine, albumin, gelatin, starch, or poly-vinyl acetate.

The tape 18 moves at a constant rate of speed about a roller 22 past the sectioning module 10. While the tape 18 is a continuous piece of tape 18, which is removed from a reel of tape, the system includes, in different embodiments, a system that is loaded with multiple reels of tape where the multiple reels of tape are sequentially moved past the module 10. Rather than being cut into strips, the embodiment depicted in FIG. 1, shows the film and the mounted sample sections (not shown) moving along in a conveyer belt fashion past the module 10. The tape moves continuously through the system at a predetermined and constant rate of speed. In one embodiment, a single film or tape is used for a single and complete tissue sample. In other embodiments, more than one tissue sample is places on a single film or tape and transitions between different samples is identified.

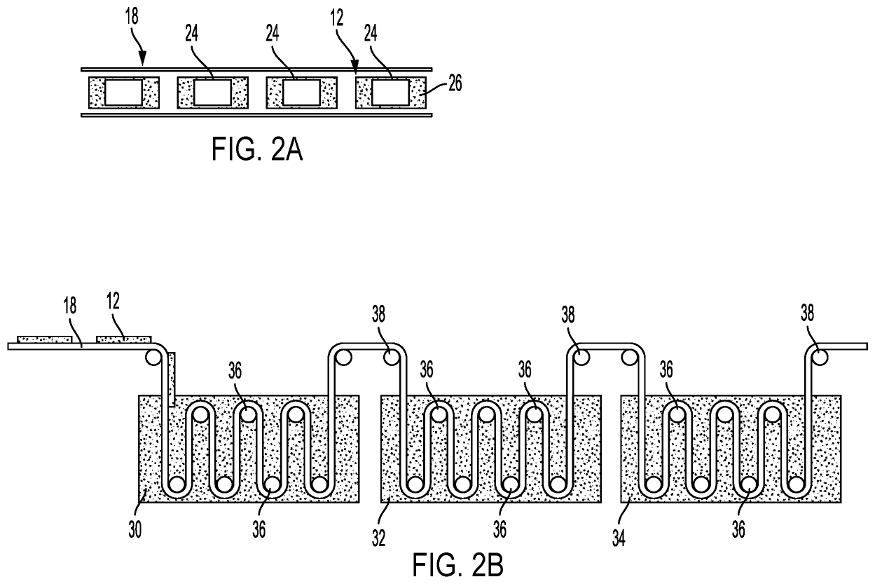

In FIG. 2A, a section of the continuous tape 18, which been loaded with individual sliced samples 12, is shown. Each of the individual samples 12 includes a tissue sample 24 that is embedded in a paraffin wax 26.

The tape 18, with tissue samples 12, moves continuously past the section module 10. The tape 18, including each tissue sample, then moves continuously from the module 10 to a dewaxing module 30, to a staining module 32, and then to a rinsing module 34. Each of these modules, includes in one or more embodiments, a chamber configured to hold a liquid solution to achieve the appropriate function of dewaxing, staining, and rinsing. The dewaxing module is also known as a deparaffinization module. Individual tissue samples are not shown in each of the modules for ease of illustration.

The dewaxing chamber 30 serves to heat each sample 12 while attached to the tape 18 and to melt the wax, which in one embodiment is paraffin. Due to the design of this embodiment, the dewaxing module 30 may be designed as a corridor lined with heating elements. Chemical washes are generally used for dewaxing as well, however, these reagents can be incorporated into and applied by the staining module. Once the samples 12 have been stained in the staining module 32, the continuous tape moves to the rinsing module 34, where it is moves in a continuous fashion.

Each of the modules 30, 32, and 34 includes a series of rollers 36 about which the moving tape is supported for passing through a respective module. Transfer rollers 38 are located between adjacent modules which move the continuous tape from one module to the next module.

The staining module 30, depicted here, includes a chamber that holds a staining solution through which the tape 18, including dewaxed samples, moves continuously. One or more reagents are held in the staining chamber and the dewaxed samples, which are submerged in the chamber, are stained. In other embodiments, multiple staining modules are used wherein each of the staining modules includes a different type of staining solution or the same solution for further staining. In this embodiment, different features of the tissues are stained sequentially to identify and isolate the different types of features. While not shown, a sealing module for this embodiment applies a liquid sealant onto each sample. This system can also be incorporated into and applied by the staining module, given by the similar mechanism. In another embodiment, the sealing module is located prior to the staining module to insure the samples are held to the tape when stained. In different embodiments, dehydrating of the tape is made when necessary or desired. Dehydrating, however, may not be necessary and is not limited to any particular step or within any particular module. In some embodiments, a dehydrating module is included as a separate module.

Each of the chambers for each module includes a particular type of solution to achieve a desired result. Consequently, the dewaxing of chamber 30 may take a first amount of time to dewax, which is different than a second amount of time to stain samples 12. To achieve the desired results in each of the modules, the chambers for each module 30, 32, and 34 may be of different sizes such that the tape remains in each chamber for a different amount of time. The time of submersion of the tape in each chamber, in some embodiments, is therefore different depending on the desired result. In another embodiment, each chamber includes a different number of support rollers which determines an amount of time the tape is located within a single module.

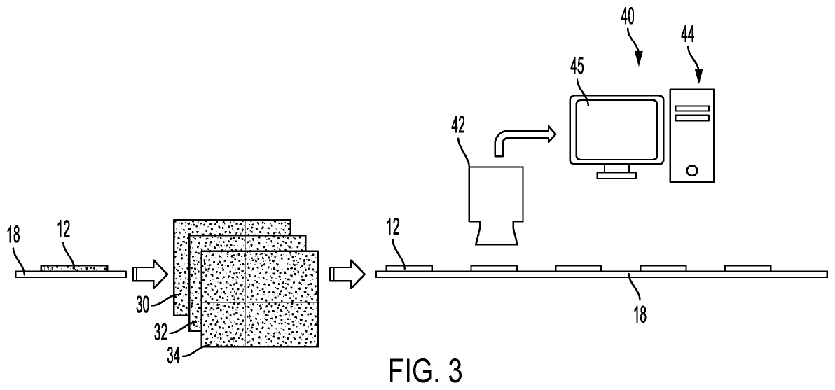

Once the tape and specimens are rinsed in the rinsing module 34, the tape 18 including the stained rinsed samples 12, moves along the conveyor system and towards an image scanning system 40 as seen in FIG. 3. The image scanning system 40 includes an imaging device 42, such as a camera, which is operatively connected to a computing system 44. In one embodiment, the camera 42 is a high speed high definition video camera. In another embodiment, the camera 42 is a single frame high definition digital camera that images one frame at a time. The digital images are transferred to the computing system 44 either by hard wiring or by wireless communication. If a digital video camera is used, the resulting digital video images, after transfer to the computing system 44, are read by computing system 44 using a digital imaging software that captures each of the images of each of the samples 12. In one embodiment, each of the samples is captured as a single image and the intervening non-image part of the tape located between images is not captured. The captured images are stored as discrete images and labeled according to type and sequence number.

To maintain a sequential order is an important consideration for this application. While there is no particular way to maintain the order, the position of a sample section along the tape confers a sequential order by design. One length of tape typically includes slices from one FFPE block and typically rolls into one scroll or reel at the end of processing. Typically, two different FFPE blocks are stored in two separate scrolls to avoid any future mixing of different FFPE blocks. If, however, blank tape having long lengths is used, the tape can be cut or otherwise labeled to mark the end of one FFPE block or the beginning of another FFPE block.

The image software performs one or types of analysis or actions, and in one embodiment, the software performs three types. The analysis includes: 1) generating a three-dimensional reconstruction of the tissue sample; 2) differentiating tissue types within the reconstruction, allowing the user to filter certain tissue types from the reconstruction and highlight target tissues within the sample; 3) using Artificial Intelligent (AI) for machine learning to facilitate disease diagnosis.

Reconstruction is accomplished by first identifying and ordering the individual tissue sections, if required. If image capture is performed consecutively, digital images are stored in the correct order. If using certain embodiments of the invention, such as the high definition video camera (a scanning module) that captures all samples on the moving tape, a separate algorithm, in one embodiment, is implemented to 1) identify and number each section within the given image, and 2) save a new set of images, each containing only one sectioned sample. In certain embodiments, a stitching function may be required to first generate a complete image of tissue sample. Once individual images are saved and ordered, a process of quality control and error correction may be implemented. By matching the high-resolution image of the processed tissue samples with the reference images taken just prior to slicing, alterations to relative position, rotation, and morphology can be observed. To aid in this process, a virtual scale or reference marker can be overlaid onto the high-resolution image. Once all images are stacked in order and corrected for errors, the process of reconstruction can begin. A reconstruction algorithm would utilize the known thickness of each cut to interpolate between 2D images and form a 3D model of the processed tissue samples.

Once reconstruction is complete, AI analysis takes place. By observing the staining patterns within the reconstruction and cross-referencing histological image databases of known cell types, both physiologic and pathologic, the AI system identifies and indicates features of the tissue sample including, but not limited to, gross structure both physiologic and pathologic, tissue type and boarders, vascular networks, etc. The software also generates dynamic 3D model of the tissue sample in which certain tissues and structures can be highlighted or removed, depending on the goals of the user. The dynamic 3d model is also can be manipulated by the user, to for instance position the 3D model from different perspectives for viewing by the user.

A user interface 45 is part of the computing system 44, and is used to access, a computer application, located at the computing system 44. The computing system includes, but is not limited to in different embodiments, a desktop computing system, a personal computing device such as a cell phone, or at a notebook device. In each of these embodiments, the user manages the settings of the integrated devices such as the module 10, modules 30, 32, and 34, scanning device 42, and computing system 44. In addition, the user manages the dynamic 3D reconstruction of the images through the user interface. Some features that may be controlled by the user include sample thickness, staining protocols, and image resolution. This list is not exhaustive. Users may also be required to indicate which embodiment of the device is in use, including which modules are incorporated.

The present invention is designed to combine all processes of histology into one high-throughput, integrated device or system. The modular nature of each component allows for great variation in the final design of the system. Determining which variant to use depends on the type of sample being analyzed and methods of analysis, especially which staining protocols. Certain modules described above can be used independently, or, in certain cases, omitted if manual processing is desired; however, the present invention is intended to be developed as an autonomous, integrated system with no or minimal user input.

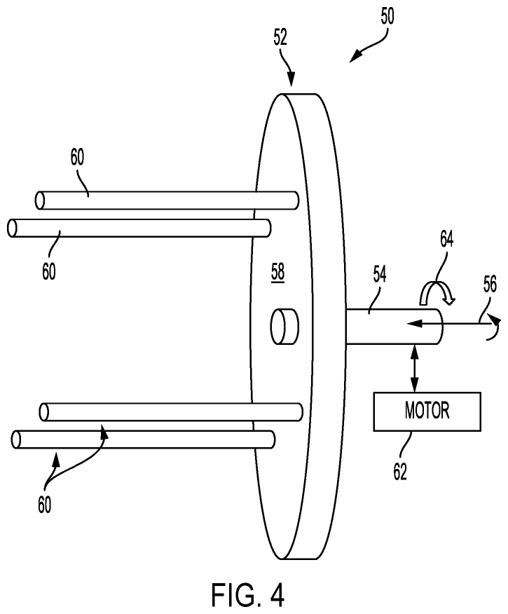

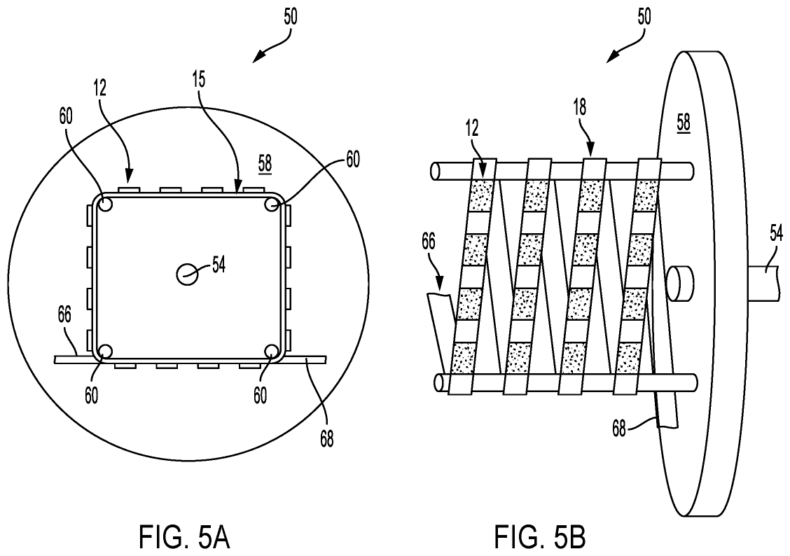

FIG. 4 illustrates a top view of a rotating staining wheel 50 for staining the tape 18 carrying sequential sample slices 12. The staining wheel 50 includes a plate 52 coupled to a spindle 54 that includes an axis 56 which is generally perpendicular to a planar surface 58 of the plate 52. A plurality of rods 60 are connected to the plate and extend generally in the direction of the axis 56. A motor 62 is operatively connected to the spindle 54 to rotate the spindle 56, plate 52, and rods 60, about a rotational axis 64. Each of the rods 60 supports the tape 18 including the samples 12 as seen in FIG. 5.

FIGS. 5A and SB illustrate a side view and a top view of the rotating staining wheel of FIG. 4 with wound tape. In an end view of FIG. 5A, the staining wheel 50 includes a tape 18 supported by the rods 60 as the wheel 58 rotates. The entire staining wheel 50, in one embodiment, is located in the staining module 32. In one embodiment, the wheel 50 rotates in the staining module 32 as the tape 18 moves through the staining container. A first end 66 of the tape 32 (see FIG. 5A) enters the staining module 32 from the dewaxing module 30. A second end 68 exits the staining module 32 and enters the rinsing module 34. In this embodiment, the tape 18 supported by staining wheel 50 is continuous and is the same tape as that which moves through each of the modules 30, 32, and 34. In one embodiment, the wheel 50 rotates with movement of the tape 18 in response to the motor 62. In another embodiment, the motor 62 is not used, the wheel is stationary, and each of the rods 60 are rotatably connected to the wheel 58. These embodiments enable the tape 18 to move smoothly as the tape 18 is transferred from the dewaxing module 30 to the rinsing module 34.

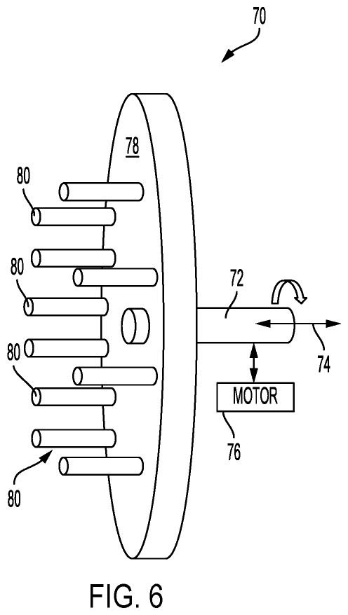

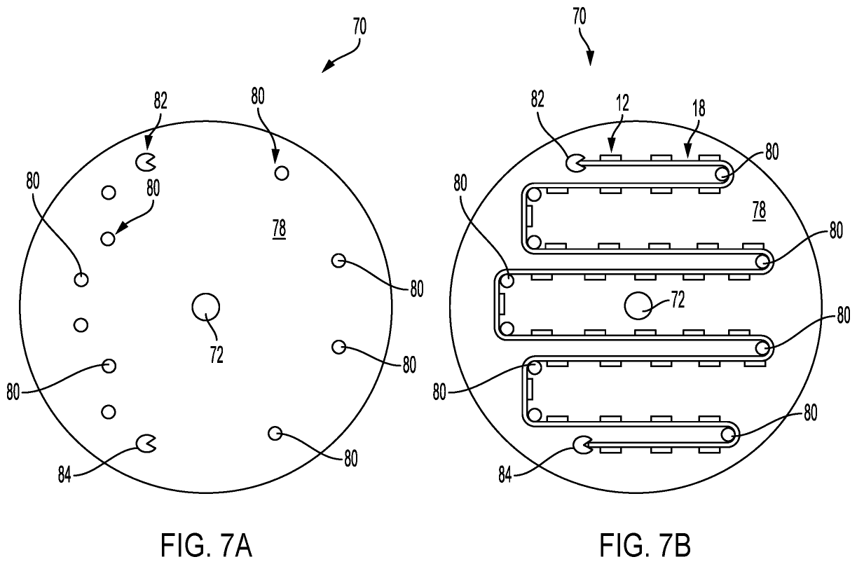

FIG. 6 illustrates another embodiment of a rotating staining wheel 70 for staining a discrete tape portion 72 as seen in FIG. 7B. In this embodiment, the staining of the tape portion 72 is made in a separate staining tank where tape portions are stained individually and then rinsed in a separate rinsing module. The staining wheel 70 includes spindle 72 rotating about an axis 74 in response to a motor 76 that drives the spindle 72. The spindle 72 is connected to a plate 78 that supports rods 80 extending from the plate 78 in a direction generally parallel to the axis 74. The tape portion 72 is threaded about the rods 80 as shown in FIG. 7B. The tape portion 72 is held to the wheel 80 at a first end by a first coupler 82 and a second coupler 84. The tape portion 72 is threaded along the rods 72 in a generally zig-zag pattern as illustrated.

In another embodiment of the staining wheel 70, the spindle 72 is not rotated and the wheel 70 is held stationary in the staining module 32 of FIG. 2. In this embodiment, the tape is continuous from the dewaxing module30, through the staining module 32, and to the rinsing module 34. The couplers 82 and 84 (see FIG. 7), in this embodiment are rods that do not couple to the tape but instead support the moving continuous tape. To insure continuous motion, each of the couplers 82 and 84 are not included and the tape proceeds from the dewaxing module 30 to rod 80A, to rod 80B, and from the rod 80B to the rinsing module 34. With the use of the rods 80, the tape with samples remains in the staining solution for a greater period of time, when compared to a tape that moves through the module 30 without being engaged by intermediate rollers.

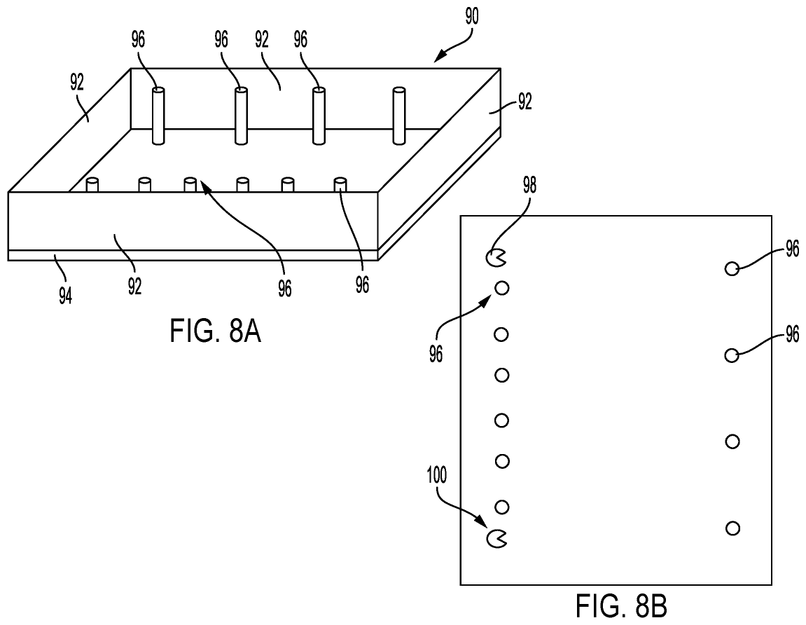

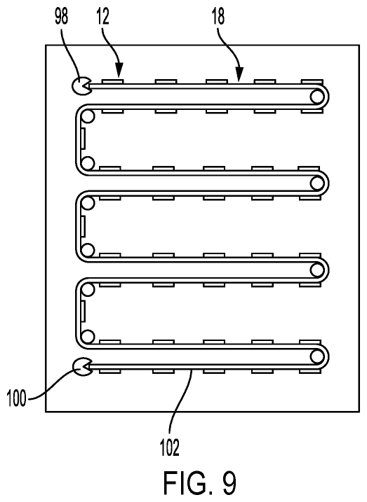

FIGS. 8A and 8B illustrate a staining tray 90 for staining the tape carrying sequential sample slices. The staining tray 90 includes sidewalls 92 and bottom wall 94 which cooperate to provide a chamber for holding the staining fluid. Rods 96 extend generally perpendicularly from the bottom wall 94. As seen in FIG. 9A a first tape clamp 98 and a second tape clamp 100 are included. The clamps 98 and 100 are used to secure ends of a tape segment 102 as seen FIG. 9. A first end of the tape segment 100 is secured to clamp 96 and a second end of the tape segment 100 is secured to tape clamp 98. In this embodiment, the staining solution can readily penetrate each of the tissue samples which may not occur if, for instance, the tape is wound on a spindle as a reel or spool where adjacent portions of the tape are in contact.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed. To the extent a definition of a term set out in a document incorporated herein by reference conflicts with the definition of a term explicitly defined herein, the definition set out herein controls.

1.-29. (canceled)

30. A system for processing a biological sample, the system comprising:
a plurality of modules configured for a continuous travel of a moving tape through each of the plurality of modules, the plurality of modules comprising:
a sectioning module configured to transfer from a block containing the biological sample a first sliced sample onto a first portion of the moving tape, the first sliced sample comprising a first portion of the biological sample; and
a staining module configured to stain at least a portion of the first sliced sample on the first portion of the moving tape while the sectioning module transfers from the block a second sliced sample onto a second portion of the moving tape while the second portion of the moving tape is connected to the first portion of the moving tape, the second sliced sample comprising a second portion of the biological sample,
wherein the staining module comprises a first plurality of rods or a first plurality of rollers to support a movement of the first portion of the moving tape through the staining module while the second portion of the moving tape travels upstream of the staining module.

31. The system of claim 30, wherein the staining module comprises the first plurality of rods, the first plurality of rods being coupled to a staining wheel, the staining wheel configured for rotational displacement.

32. The system of claim 31, wherein at least a portion of the plurality of rods are coupled to the moving tape as the moving tape is engaged with the portion of the plurality of rods.

33. The system of claim 30, wherein the plurality of modules further comprises a dewaxing module positioned downstream of the sectioning module and upstream of the staining module, wherein the dewaxing module is configured to remove, as the continuous travel of the moving tape continues, a wax from the first sliced sample.

34. The system of claim 33, wherein the dewaxing module comprises a second plurality of rollers to support a movement of the moving tape through the dewaxing module.

35. The system of claim 30, wherein the plurality of modules further comprises a rinsing module positioned downstream of the staining module, the rinsing module comprising a third plurality of rollers to support a movement of the moving tape through the rinsing module.

36. The system of claim 30, wherein the first sliced sample is a plurality of first sliced samples, and wherein the second sliced sample is a plurality of second sliced samples.

37. The system of claim 30, wherein the plurality of modules further comprises a sealing module positioned downstream of the staining module, the sealing module configured to selectively apply a cover onto the first sliced sample as the continuous travel of the moving tape continues.

38. A method for processing a biological sample, the method comprising:
transferring, at a sectioning module and from a block containing the biological sample, a first sliced sample onto a first portion of a tape as the tape moves through at least the sectioning module and a staining module;
staining, at the staining module, at least a portion of the first sliced sample on the first portion of the tape while a second sliced sample is transferred onto a second portion of the tape, the second sliced sample comprising a second portion of the biological sample, the first and second portions of the tape being connected during the transfer of the second sliced sample onto the second portion of the tape,
wherein the staining module comprises a first plurality of rods or a first plurality of rollers to support a movement of the first portion of the tape through the staining module while the second portion of the tape travels upstream of the staining module.

39. The method of claim 38, wherein the staining module comprises the first plurality of rods coupled to a staining wheel, and wherein the method further comprises rotating the staining wheel.

40. The method of claim 38, further comprising moving the tape along a second plurality of rollers positioned in a dewaxing module while the tape is also moved along at least the sectioning module and the staining module, the dewaxing module configured for removal of a wax from each of the first and second sliced samples.

41. The method of claim 40, further comprising moving the tape along a third plurality of rollers positioned in a rinsing module while the tape is also moved along at least the sectioning module and the staining module.

42. The method of claim 41, further comprising moving the tape along a sealing module positioned downstream of the staining module, the sealing module configured to selectively apply a cover onto the first sliced sample while the tape is also moved along at least the sectioning module and the staining module.

43. The method of claim 38, further comprising slicing, at the sectioning module, the block to obtain the first sliced sample.

44. A method for comprising:
transferring a first sample onto a first portion of a continuous tape; and
advancing, along a first series of rollers, the first portion of the continuous tape having the first sample through one or more reagent baths while a second sample is transferred to a second portion of the continuous tape, the first portion of the continuous tape being coupled to the second portion of the continuous tape along a length of the continuous tape as the first sample is advanced to the one or more reagent baths.

45. The method of claim 44, further comprising advancing, along a second series of rollers, the first portion of the continuous tape for a removal of a wax from the first sample while the first portion of the continuous tape is coupled to the second portion of the continuous tape.

46. The method of claim 45, further comprising advancing, along a third series of rollers, and after advancing the first portion through the one or more reagent baths, the first portion of the continuous tape for a rinsing of the first sample while the first portion of the continuous tape is coupled to the second portion of the continuous tape.

47. The method of claim 46, further comprising sealing the first sample while the first sample and the second sample are on the continuous tape and the first portion of the continuous tape remains coupled to the second portion of the continuous tape.

48. The method of claim 45, further comprising slicing a block containing a biological sample to obtained the first sample.

49. The method of claim 45, wherein the first sample comprises a plurality of first samples sequentially transferred to the continuous tape, and the second sample comprises a plurality of second samples sequentially transferred to the continuous tape.
